(19) United States
(12) Patent Application Publication
(10) Pub. No.: US 2025/0315286 A1
(43) Pub. Date: Oct. 9, 2025

(54) TRANSPARENTLY SERVICING A HOST COMPUTE LAYER OF A VIRTUAL MACHINE

(71) Applicant: Microsoft Technology Licensing, LLC, Redmond, WA (US)

(72) Inventors: Bruce John SHERWIN, JR., Woodinville, WA (US); Kevin Michael BROAS, Kirkland, WA (US); John Andrew STARKS, Seattle, WA (US); Christopher Wei-Kwan OO, Bellevue, WA (US); Michael Bishop EBERSOL, Woodinville, WA (US); Vignesh Kudigrama SHENOY, Snohomish, WA (US); Patrick Alexandre PERRIER, Seattle, WA (US)

(21) Appl. No.: 18/627,218

(22) Filed: Apr. 4, 2024

(51) Int. Cl. G06F 9/455

(52) U.S. Cl. CPC G06F 9/45545; G06F 9/45558; G06F 2009/45575

(57) ABSTRACT

A method is disclosed for updating a host compute layer (HCL) in a virtual machine (VM) host computer system. The method involves determining the availability of an update for the HCL of a guest VM operating on the VM host system. A message is sent to the HCL to persist the HCL's operating state, including pausing the execution of the guest operating system (OS) and then persisting the operating state. Subsequently, the virtual processor (VP) system associated with the guest VM is stopped, a register is set to a power-on or reset value, and updated HCL code is copied into the memory space of the HCL. The VP system is then resumed, booting the updated HCL, which restores the operating state and resumes the execution of the guest OS.

### BACKGROUND

Hypervisor-based virtualization technologies allocate portions of a computer system's physical resources (e.g., processor resources, physical memory resources, storage resources) into separate partitions, and execute software within each partition. Hypervisor-based virtualization technologies, therefore, facilitate the creation of virtual machines (VMs) that each executes guest software, such as an operating system (OS) and applications executing therein. A computer system that hosts VMs is commonly called a VM host or a VM host node.

While hypervisor-based virtualization technologies can take various forms, many use an architecture comprising a type-one, or bare-metal, hypervisor that has direct access to hardware and operates in a separate execution environment from all other software in the computer system. A type-one hypervisor creates a host (or root) partition (e.g., a host VM) and one or more guest partitions (e.g., guest VMs). Each partition comprises an isolated slice of the underlying hardware of the VM host, such as memory and processor resources. The host partition executes a host OS and a host virtualization stack that manages the guest partitions. Thus, the hypervisor grants the host partition a greater level of access to the hypervisor and to hardware resources than it does to guest partitions. Other hypervisor-based architectures comprise a type-two, or hosted, hypervisor that executes within the context of an underlying OS, and that creates one or more guest partitions.

Taking HYPER-V from MICROSOFT CORPORATION as one example, the HYPER-V hypervisor is a type-one hypervisor making up the lowest layer of a HYPER-V stack. The HYPER-V hypervisor provides basic functionality for dispatching and executing virtual processors for VMs. The HYPER-V hypervisor takes ownership of hardware virtualization capabilities (e.g., second-level address translation processor extensions such as rapid virtualization indexing from ADVANCED MICRO DEVICES, or extended page tables from INTEL; an input/output (I/O) memory management unit that connects a direct memory access-capable I/O bus to main memory; processor virtualization controls). The HYPER-V hypervisor also provides a set of interfaces to allow a HYPER-V host stack within a host partition to leverage these virtualization capabilities to manage VMs. The HYPER-V host stack provides general functionality for VM virtualization (e.g., memory management, VM lifecycle management, device virtualization).

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products, including, in a virtual machine (VM) host computer system: determining that an update is available for a host compute layer (HCL) of a guest VM operating at the VM host computer system; sending a message to the HCL of the guest VM, wherein, based on the message, the HCL persists an operating state of the HCL, including, pausing execution of a guest operating system (OS) within the guest VM and persisting the operating state after pausing the execution of the guest OS; and after sending the message to the HCL of the guest VM, stopping a virtual processor (VP) system associated with the guest VM, setting a register at the VP system to a power-on value or a reset value, copying an updated HCL into a memory space of the HCL within the guest VM, and resuming the VP system, wherein, based on the register, the VP system executes the updated HCL, which restores the operating state and resumes the execution of the guest OS after restoring the operating state.

In some aspects, the techniques described herein relate to methods, systems, and computer program products, including, in HCL of a guest VM that includes a VP system: receiving a message from a host partition to persist an operating state of the HCL; based on the message pausing execution of a guest OS within the guest VM and persisting the operating state after pausing the execution of the guest OS; and after persisting the operating state, booting HCL code, including restoring the operating state and resuming the execution of the guest OS after restoring the operating state.

In some aspects, the techniques described herein relate to methods, systems, and computer program products, including, at a host partition: determining that an update is available for a HCL of a guest VM; sending a message to the HCL; and after sending the message to the HCL, stopping a VP system associated with the guest VM, setting a register at the VP system to a power-on value or a reset value, copying an updated HCL into a memory space of the HCL within the guest VM, and resuming the VP system; and at the guest VM: based on receiving the message from the host partition, pausing execution of a guest OS within the guest VM and persisting operating state after pausing the execution of the guest OS; and based on the host partition resuming the VP system, and based on the register at the VP system, booting the updated HCL, including restoring the operating state and resuming the execution of the guest OS after restoring the operating state.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture that facilitates transparently servicing host compute layers (HCLs) at virtual machines (VMs).

FIG. 2 illustrates an example of an HCL servicing component.

FIG. 3 illustrates of persisting HCL state at a guest partition.

FIG. 4 illustrates of persisting HCL state at a host partition.

FIGS. 5A and 5B illustrate a flow chart of an example of a method for transparently servicing an HCL of a VM.

### DETAILED DESCRIPTION

Conventionally, guest operating systems (OSs) have executed directly within their respective partition. This means that a guest OS has conventionally had full access to, and control of, virtual hardware presented by the hypervisor to the guest partition, such as virtual processors (VPs), guest virtual memory, virtual hardware devices, and the like. More recently, however, some hypervisors have further divided guest partitions into different privileged contexts, including a lower-privileged context and a higher-privileged context. For example, HYPER-V includes virtualization-based security (VBS) technology, which uses hardware virtualization features, such as second-level address translation (SLAT), to create isolated memory contexts within a given partition, or guest virtual machine (VM). Using VBS, the HYPER-V hypervisor can sub-partition a guest partition's guest memory into different virtual trust levels (VTLs), including, for example, a higher-privileged VTL (e.g., VTL2) and a lower-privileged VTL (e.g., VTL0). In these environments, the guest OS executes within the lower-privileged VTL (e.g., VTL0), while separate software executes in the higher-privileged VTL (e.g., VTL2) and provides services to the guest OS.

In this disclosure and the claims, software that executes in a higher-privileged context of a partition or guest VM, independently from a guest OS, is referred to as a “host compute layer” (HCL). In some embodiments, this HCL includes hypervisor-like functionality and thus operates, at least in part, as a para-virtualization layer (e.g., a “paravisor”) and/or a virtual machine monitor (VMM). Examples of services that an HCL may provide include emulated hardware (e.g., an emulated non-volatile memory express (NVMe) controller), baseboard management controller functionality for monitoring and managing a guest partition, a virtual trusted platform module, and the like.

It may sometimes be necessary to update an HCL, for example, to fix bugs or add features. Currently, this is accomplished by restarting a guest VM, including shutting down the guest OS and the HCL, inserting updated HCL code into the guest VM, booting the updated HCL code, and then booting the guest OS. However, there are several drawbacks to this approach.

First, this update process is extremely disruptive to the guest VM, requiring a complete reboot of the guest OS and the workload executing thereon. This means that HCL updates may need to be deferred until the guest VM is being serviced, such as to install guest OS updates.

Second, this update process is difficult to carry out over a fleet of VM hosts, each of which may operate many guest VMs. For example, as mentioned, an HCL can only be updated at a given guest VM when that guest VM is being serviced or otherwise restarted. Thus, it is difficult, or even impossible, for an administrator of a VM hosting environment to ensure that HCLs are updated across all applicable VMs and VM hosts in a timely or predictable manner. This means there may be an inconsistency in the versions of the HCL code being used, and a delay in rolling out fixes for bugs, including security issues.

At least some embodiments described herein enable the servicing of HCLs at guest VMs in a manner that is transparent and non-disruptive to the guest OSs executing thereon. In embodiments, a servicing component at a host partition of a VM host determines that an update is available for the HCL of a guest VM at the VM host. This servicing component sends a message to the HCL of the guest VM. Based on receiving this message, the HCL pauses the execution of a guest OS within the guest VM. Then, the HCL persists its operating state (e.g., one or more VP registers, virtual hardware device state, physical hardware device state). After the HCL has persisted its operating state, the servicing component stops the guest VM's VP(s), copies updated HCL code into a memory space of the HCL, configures the guest VM's VP(s) to boot the updated HCL, and resumes the guest VM's VP(s). The HCL then boots the updated HCL code, which is configured to restore the persisted operating state and then resume the execution of the guest OS. In some embodiments, the entire servicing process—from pausing the guest OS to resuming the guest OS—can be completed in less than a second, leading to negligible blackout times for the guest OS and the services operating thereon.

These embodiments of servicing an HCL enable the HCL of a guest VM to be updated without shutting down a guest OS at the guest VM, and any workloads executing thereon. Thus, HCL can be accomplished independently of guest OS servicing and, as mentioned, with negligible blackout times for the guest OS and the services operating thereon. This means that administrators of VM hosting environments ensure that HCLs are updated across all applicable VMs and all applicable VM hosts in a timely and predictable manner.

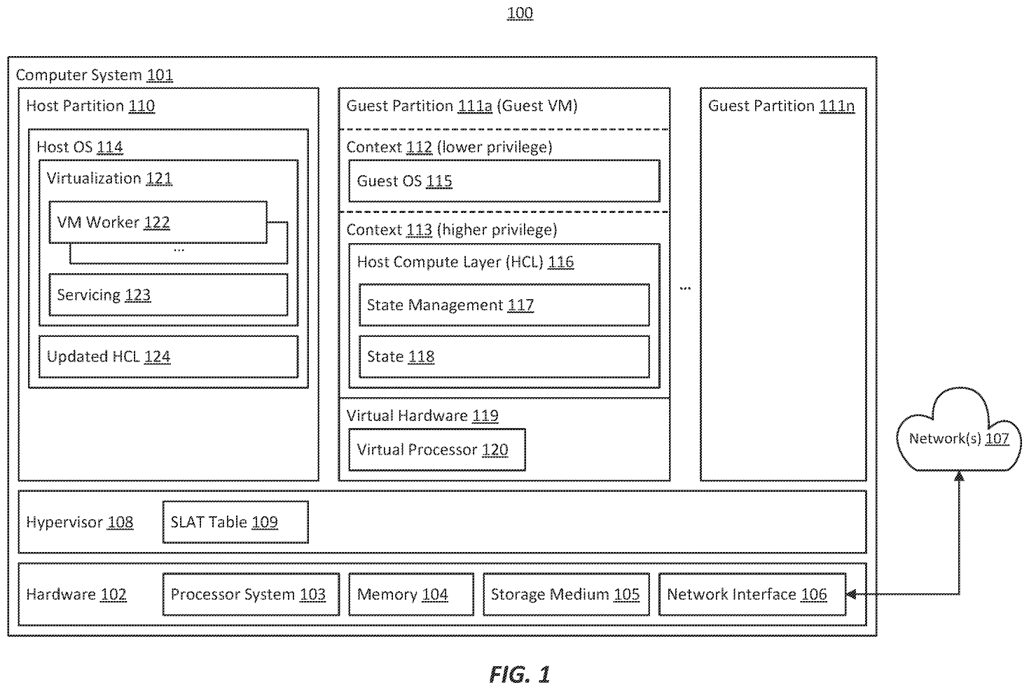

FIG. 1 illustrates an example computer architecture 100 that facilitates transparently servicing HCLs at VMs. As shown, computer architecture 100 includes a computer system 101 (e.g., a VM host) that comprises hardware 102. Examples of hardware 102 include a processor system 103 (e.g., a single processor, or a plurality of processors), a memory 104 (e.g., system or main memory), a storage medium 105 (e.g., a single computer-readable storage medium, or a plurality of computer-readable storage media), and a network interface 106 (e.g., one or more network interface cards) for interconnecting, via network(s) 107, to one or more other computer systems (not shown). Although not shown, hardware 102 may also include other hardware devices, such as a trusted platform module (TPM) for facilitating measured boot features, an input/output (I/O) memory management unit (IOMMU) that connects a direct memory access (DMA)-capable I/O bus to memory 104, a video display interface for connecting to display hardware, a user input interface for connecting to user input devices, an external bus for connecting to external devices, and the like.

As shown, in computer architecture 100, a hypervisor 108 executes directly on hardware 102. In general, hypervisor 108 partitions hardware resources (e.g., processor system 103, memory 104, I/O resources) among a host partition 110, within which a host OS 114 executes, and a guest partition 111a, within which a guest OS 115 executes. As ellipses indicate, hypervisor 108 may partition hardware resources into a plurality of guest partitions (e.g., guest partition 111a to guest partition 111n; collectively, guest partitions 111), each executing a corresponding guest OS.

As shown, host OS 114 includes a virtualization component 121, which manages the guest VMs (e.g., virtual processor management, memory management, lifecycle management) via application program interface (API) calls to hypervisor 108. The example illustrates virtualization component 121 as including a VM worker 122 (or a plurality of VM workers) and an HCL servicing component (servicing component 123). However, virtualization component 121 is not limited to these components and functionality.

Each VM worker 122 corresponds to a different guest partition of guest partitions 111 and manages the guest VM corresponding to that partition. In embodiments, each VM worker 122 divides its corresponding guest partition into different privileged zones, herein referred to as guest privileged contexts. Thus, for example, guest partition 111a comprises a first guest context (context 112) and a second guest context (context 113). In embodiments, context 112 is a lower privileged context (e.g., when compared to context 113), and context 113 is a higher privileged context (e.g., when compared to context 112). In these embodiments, context 112 having a lower privileged than context 113 means that context 112 cannot access guest partition memory allocated to context 113. In some embodiments, context 113 can access guest partition memory allocated to context 112. In other embodiments, context 113 lacks access to guest partition memory allocated to context 112.

In some embodiments, context 112 and context 113 are created based on a SLAT table 109 that maps system physical addresses (SPAs) within memory 104 to guest physical addresses (GPAs) seen by guest partition 111a. In these embodiments, these mappings prevent context 112 from accessing memory allocated to context 113. In one example, hypervisor 108 is the HYPER-V hypervisor, which utilizes VBS to create different VTLs. In this example, context 113 operates under VBS in a higher privileged VTL (e.g., VTL2), and context 112 operates under VBS in a lower privileged VTL (e.g., VTL0). In other embodiments, context 112 and context 113 are created based on nested virtualization, e.g., in which guest partition 111a operates a hypervisor that partitions resources of guest partition 111a into sub-partitions. In these embodiments, this hypervisor operating within guest partition 111a prevents context 112 from accessing memory allocated to context 113.

In computer architecture 100, context 113 executes software (e.g., a kernel, and processes executing thereon) separately from context 112 and provides one or more services to guest OS 115. Thus, context 113 is shown as operating an HCL 116 (e.g., paravisor, VMM).

The servicing component 123 operates to update the HCL at each guest partition when an update is available and does so in a manner that is transparent to the guest OSs operating at each guest partition. Thus, for example, servicing component 123 updates HCL 116 with updated HCL 124 when updated HCL 124 becomes available to computer system 101. In some embodiments, updated HCL 124 is provided to computer system 101 by VM host management fabric that manages a plurality of VM hosts, including computer system 101.

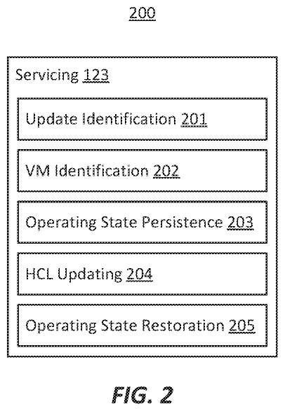

FIG. 2 illustrates an example 200 of the servicing component 123 of FIG. 1. Each component of servicing component 123 depicted in FIG. 2 represents various functionalities that servicing component 123 may implement under the embodiments described herein. These components, including their identity and arrangement, are presented merely as an aid in describing example embodiments of servicing component 123. Notably, in some embodiments, some, or even all, of the components depicted as part of servicing component 123 may reside within each VM worker 122.

In example 200, servicing component 123 includes an update identification component 201, which identifies the availability of an HCL update, such as updated HCL 124 (e.g., an HCL update file). The update identification component 201 can discover an HCL update file in various ways. In some examples, update identification component 201 discovers an HCL update when an update file is copied to a defined location at host OS 114. In other examples, update identification component 201 discovers an HCL update based on a notification from a VM host management fabric (e.g., a notification received network(s) 107). Other mechanisms are also within the scope of this disclosure.

In some embodiments, update identification component 201 performs one or more checks on the HCL update, such as to determine if an update file is well-formed (e.g., based on calculating a hash or checksum of the update file and comparing the calculated hash/checksum with a known value, based on validating contents of the update file).

In example 200, servicing component 123 also includes a VM identification component 202. In embodiments, VM identification component 202 determines which guest VM(s) operating at computer system 101 have an HCL that can be updated based on the identified HCL update. In one example, VM identification component 202 determines that HCL 116 at guest partition 111a is a prior version of updated HCL 124. In another example, VM identification component 202 determines that HCL 116 at guest partition 111a is compatible with updated HCL 124 as it is presently running or configured. For instance, VM identification component 202 determines that HCL 116 uses parameters that are compatible with updated HCL 124, such as a compatible memory-mapped I/O (MMIO) size (e.g., updated HCL 124 uses or supports an MMIO size that is no larger than the MMIO size used by HCL 116).

In embodiments, VM identification component 202 also determines which guest VM(s) operating at computer system 101 that have a compatible HCL are in a state that can be updated. In one embodiment, VM identification component 202 determines that a guest VM is in a state that can be updated based at least on determining that the guest VM has a VP system that is running. For example, referring to guest partition 111a, the guest partition includes virtual hardware 119, including VP 120 (or a plurality of VPs). In embodiments, if no VP is running at guest partition 111a (e.g., because the guest VM is paused or suspended, or because none of the guest VM's VP(s) are presently scheduled for execution at processor system 103), then the servicing component 123 cannot presently update HCL 116 at guest partition 111a. In embodiments, if this is the case, VM identification component 202 waits until the guest VM has at least one VP system running before it proceeds with the HCL update.

In example 200, servicing component 123 also includes an operating state persistence component 203, which triggers HCL 116 to persist the HCL's operating state. For example, in FIG. 1, HCL 116 is illustrated as including a state management component 117, which pauses the execution of guest OS 115 and then persists state 118 to a location that will survive a restart of HCL 116. In general, state 118 comprises any information (e.g., within the memory space of HCL 116) that would be needed to boot a new instance of HCL 116 and restore that new instance to a state that would enable it to resume execution of guest OS 115 and provide guest OS 115 any services the prior instance of HCL 116 was previously providing guest OS 115. Thus, in embodiments, state 118 includes the state of any services that HCL 116 was providing to guest OS 115 at the time that the execution of guest OS 115 was paused. Examples of state 118 include one or more register values of VP 120 that would be needed to resume execution of guest OS 115 (e.g., an instruction pointer register), the state of a virtual hardware device that the HCL presents to guest OS 115, the driver state of a physical hardware device assigned to guest partition 111a, and the like.

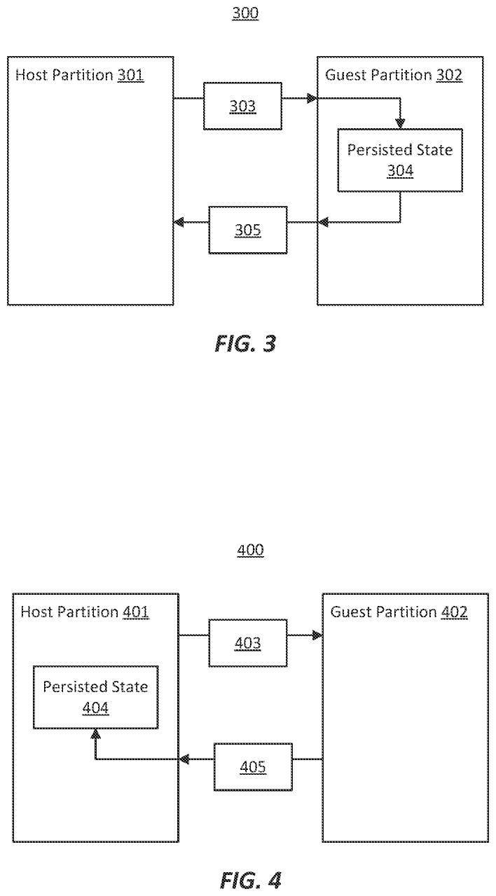

The manner of persisting an HCL's operating state can vary, depending on implementation. In one embodiment, an HCL persists its operating state to a location within its memory space (e.g., context 113) within a guest partition. FIG. 3 illustrates an example 300 of persisting HCL state at a guest partition. In example 300, a host partition 301 sends a message 303 to a guest partition 302, instructing the HCL at the guest partition to persist the HCL's operating state. For example, operating state persistence component 203 sends a message to HCL 116. As a result, the guest partition 302 stores persisted state 304 locally and sends host partition 301 a message 305 to inform host partition 301 that the persisting of the HCL state is complete. For example, state management component 117 persists state 118 within memory assigned to context 113 and then sends a message to operating state persistence component 203.

In embodiments, the state management component 117 persists the state 118 at a memory location that another instance of HCL 116 can later identify. In some embodiments, this is based on convention, such as offset from a base memory address, a memory address calculated based on attributes of context 113, and the like. In some embodiments, state management component 117 also persists some value (e.g., a predetermined set of one or more bits) that another instance of HCL 116 can use to determine if any persisted state resides at that memory location.

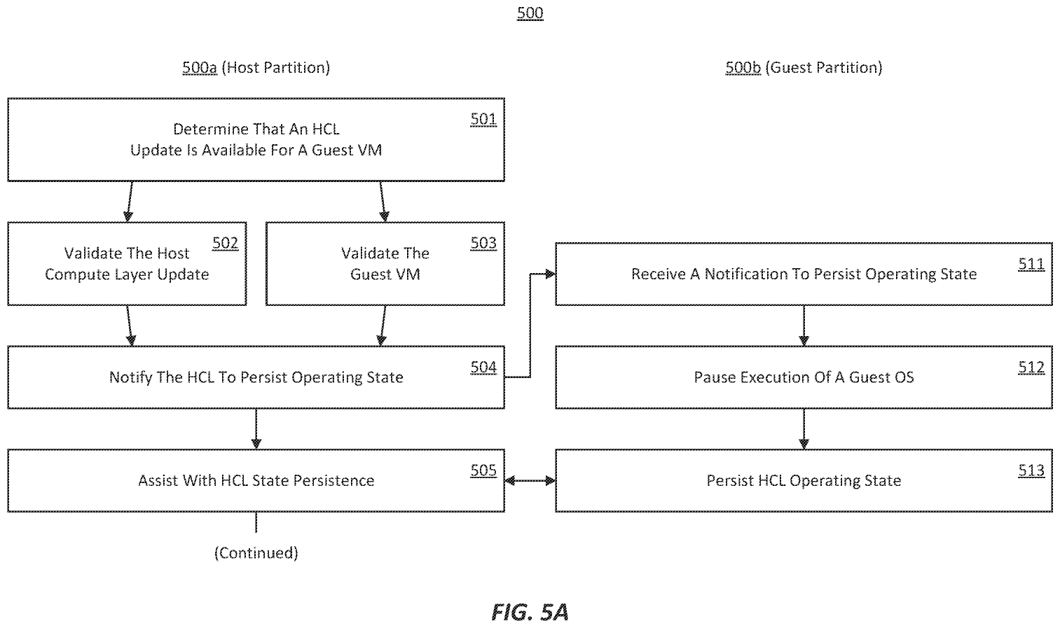

In another embodiment, an HCL persists the HCL's operating state to a host partition. FIG. 4 illustrates an example 400 of the persisting of HCL state to a host partition. In example 400, a host partition 401 sends a message 403 to a guest partition 402, instructing an HCL at the guest partition to persist the HCL's operating state. As a result, the guest partition 402 sends the operating state to host partition 401 (message 405). Then, host partition 401 persists the state locally (persisted state 404).

Notably, variations of these examples are also possible. For instance, one variation persists state 118 within context 113 (e.g., example 300) but notifies operating state persistence component 203 of the address of a memory location where that state can be found. Thus, host partition 110 stores the address, and provides it to the updated HCL at a later time.

In example 200, servicing component 123 also includes HCL updating component 204, which halts the HCL, copies updated HCL 124 into the guest partition, configures the guest partition to boot the updated HCL, and resumes the guest partition's VP(s). For example, HCL updating component 204 stops VP 120 (which, in turn, halts the execution of HCL 116), copies updated HCL 124 into the memory space of context 113 (e.g., replacing prior HCL code), configures VP 120 to be in a power-on value or reset state (e.g., by setting a value of an instruction pointer register to a memory address at the beginning of HCL boot code) and resumes VP 120. As a result, the updated HCL boots within context 113. In embodiments, this HCL is configured to restore state 118 from where the prior HCL persisted state 118 and to then resume guest OS 115.

As mentioned, some embodiments persist state 118 within the HCL's memory space (e.g., example 300). In these embodiments, the new HCL restores the state 118 from its memory space. Other embodiments persist state 118 at the host partition (e.g., example 400). In these embodiments, an operating state restoration component 205 participates in restoring the persisted HCL state. As mentioned, variations are also possible, such as the host partition storing a memory address for the location within the HCL's memory space where the HCL has persisted the state 118. In this variation, operating state restoration component 205 provides this memory address to the HCL.

The following discussion now refers to methods and method acts. Although the method acts are discussed in specific orders or are illustrated in a flow chart as occurring in a particular order, no order is required unless expressly stated or required because an act is dependent on another act being completed before the act is performed.

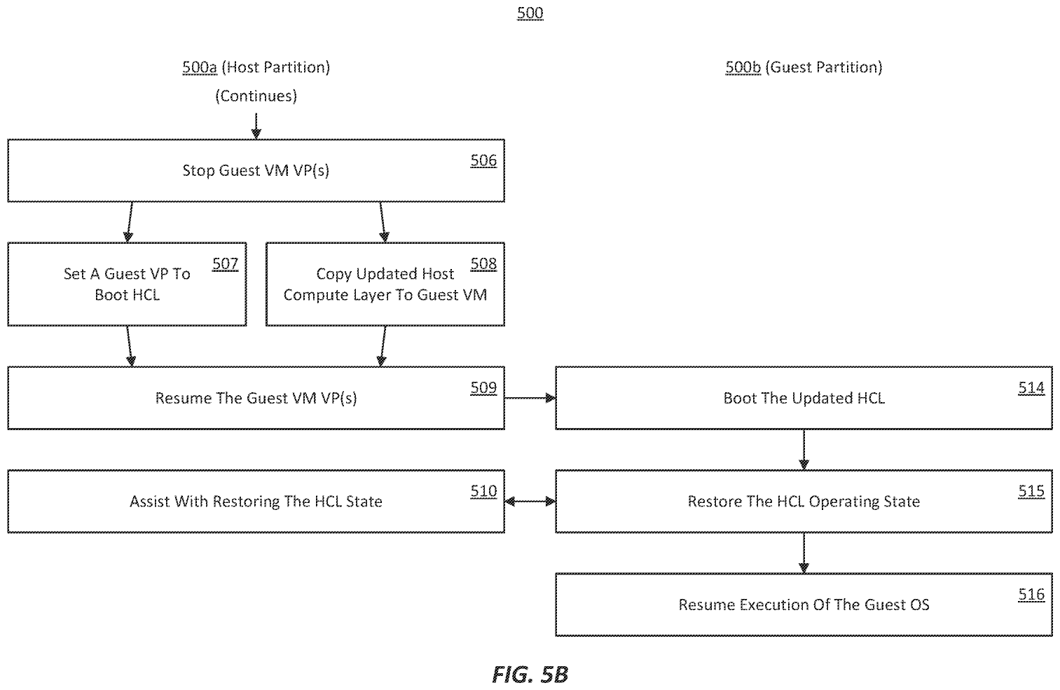

Embodiments are now described in connection with FIGS. 5A and 5B, which illustrate a flow chart of an example method 500 for transparently servicing an HCL of a VM. In embodiments, instructions for implementing method 500 are encoded as computer-executable instructions stored on a computer storage media (e.g., storage medium 105) that are executable by a processor (e.g., processor system 103) to cause a computer system (e.g., computer system 101) to perform method 500.

As shown, the acts of method 500 are divided into method 500a, performed at a host partition (e.g., host partition 110), and method 500b, performed at a guest partition (e.g., guest partition 111a). In some embodiments, method 500 is a single method performed at a VM host (e.g., computer system 101). In other embodiments, method 500 comprises independent methods, including method 500a performed at a host partition (e.g., host partition 110, based on servicing component 123) and method 500b performed at a guest partition (e.g., guest partition 111a, based on state management component 117).

Method 500 operates to update the HCL at a single guest VM. In embodiments, a given VM host (e.g., computer system 101) performs method 500 for each guest VM to which an HCL update can be applied.

Referring to FIG. 5A, in embodiments, method 500a comprises act 501 of determining that an HCL update is available for a guest VM. In some embodiments, act 501 comprises determining that an update is available for the HCL of a guest VM operating at the VM host computer system. For example, based on update identification component 201 having identified updated HCL 124, VM identification component 202 determines that updated HCL 124 applies to HCL 116 operating within context 113 at guest partition 111a.

In some embodiments, method 500a also comprises act 502 of validating the HCL update. In embodiments, act 502 comprises validating the updated HCL. For example, update identification component 201 determines if an HCL update file is well-formed, e.g., based on calculating a hash or checksum of the file, based on validating contents of the HCL update file, and the like. Additionally, or alternatively, in embodiments, act 502 comprises validating that the HCL update file is compatible with the HCL. For example, VM identification component 202 determines that updated HCL 124 and HCL 116 use compatible parameters, such as a compatible MMIO size.

In some embodiments, method 500a also comprises act 503 of validating the guest VM. In some embodiments, act 503 comprises determining whether the guest VM is in a state that permits updating the HCL. In embodiments, this includes determining whether the VP system at the guest VM is running. In embodiments, an HCL update is only initiated when at least one VP system as the guest VM is running.

Thus, in one example, act 503 comprises determining that the guest VM is in a state that permits updating the HCL, including determining that the VP system is running. For instance, VM identification component 202 determines that VP 120 is running at guest partition 111a. In this example, method 500a can proceed from act 503 to act 504.

In another example, act 503 comprises determining that the guest VM is in a state that prevents updating the HCL, including determining that the VP system is not running. For instance, VM identification component 202 determines that VP 120 is not running at guest partition 111a. In this example, method 500a waits to proceed from act 503 to act 504 until the VP system is running. Thus, in this example, act 503 may comprise deferring act 504 (e.g., until the VP system is running and VM is in a state in which the update may be performed), scheduling the initiation of act 504 for when the VP system is running, etc.

No ordering is required between act 502 and act 503 in FIG. 5A. Thus, in various implementations, these acts could be performed serially (in either order) or at least partially in parallel.

After completing each of act 502 and act 503, if present, method 500a also comprises act 504 of notifying the HCL to persist the HCL's operating state. In some embodiments, act 504 comprises sending a message to the HCL of the guest VM. For example, operating state persistence component 203 sends a message to HCL 116, indicating that HCL 116 should persist the HCL's state.

Turning to method 500b, based on act 504, method 500b comprises act 511 of receiving a notification to persist operating state. In some embodiments, act 511 comprises receiving a message from a host partition to persist the operating state of the HCL. For example, HCL 116 receives the message that was sent by operating state persistence component 203 in act 503.

Method 500b also comprises act 512 of pausing execution of a guest OS. In some embodiments, act 512 comprises, based on the message, pausing the execution of a guest OS within the guest VM. For example, state management component 117 pauses the execution of guest OS 115 by, for example, preventing VP 120 from executing guest OS 115.

Method 500b also comprises act 513 of persisting HCL operating state. In some embodiments, act 513 comprises persisting the operating state after pausing the execution of the guest OS. For example, state management component 117 persists state 118 of HCL 116 to a location accessible to another instance of HCL 116 booting within context 113. In embodiments, the operating state includes at least one of a register value at the VP system that was written by the guest OS before the guest OS was paused, the state of a virtual hardware device operated by the HCL, the state of a physical hardware device assigned to the guest VM, and the like.

As mentioned in connection with FIGS. 3 and 4, in various embodiments, persisting the operating state may include persisting the state to a location within the HCL's memory space (e.g., context 113) or to a host partition. For example, in some embodiments, state management component 117 persists state 118 to guest memory within context 113. In these embodiments, persisting the operating state to the storage includes saving the operating state to a memory block within the guest memory space of the HCL. As discussed, in various embodiments, the memory block is determined by the HCL based on convention, and saving the operating state to the memory block includes writing a value indicating that the operating state is stored at the memory block.

In other embodiments, state management component 117 persists state 118 to host partition 110. In these embodiments, persisting the operating state to the storage includes sending the operating state to a host partition. Returning to method 500a, in some embodiments, method 500a comprises act 505 of assisting with HCL state persistence. For example, operating state persistence component 203 receives the state from guest partition 111a and saves that state at host partition 110.

As mentioned, variations are also possible, such as persisting the state 118 within context 113 but notifying operating state persistence component 203 of the memory location at which that state can be found. Thus, in some embodiments, saving the operating state to the memory block within the memory space of the HCL includes sending an identity of a location of the memory block within the memory space of the HCL to the host partition.

Turning to FIG. 5B, method 500a also comprises act 506 of stopping guest VM VP(s). In some embodiments, act 506 comprises, after sending the message to the HCL of the guest VM, stopping a VP system associated with the guest VM. For example, HCL updating component 204 stops VP 120, resulting in the halting of the execution of HCL 116.

Method 500a also comprises act 507 of setting a guest VP to boot the HCL. In some embodiments, act 507 comprises setting a register at the VP system to a power-on value or a reset value. For example, HCL updating component 204 configures at least one register of VP 120 to a power-on value or reset state. For instance, HCL updating component 204 sets the value of an instruction pointer register to a memory address at the beginning of the updated HCL's boot code.

Method 500a also comprises act 508 of copying an updated HCL to the guest VM. In some embodiments, act 508 comprises copying an updated HCL into a memory space of the HCL within the guest VM. For example, HCL updating component 204 copies updated HCL 124 (e.g., an HCL update file) into context 113.

No ordering is required between act 507 and act 508 in FIG. 5B. Thus, in various implementations, these acts could be performed serially (in either order) or at least partially in parallel.

After completing each of act 507 and act 508, method 500a also comprises act 509 of resuming the guest VM VP(s). In some embodiments, act 509 comprises resuming the VP system. For example, HCL updating component 204 resumes VP 120.

Returning to method 500b, based on act 509, method 500b also comprises act 514 of booting the updated HCL. In some embodiments, act 514 comprises, based on the register, booting HCL code. Thus, the VP system executes the updated HCL. For example, based on HCL updating component 204 having configured at least one register of VP 120 to a power-on value or reset state in act 507, when VP 120 resumes, the VP initiates booting of the updated HCL code copied into context 113 in act 508.

In some embodiments, based on convention, booting the HCL includes excluding a memory block that includes the storage from use by HCL services. This prevents the HCL from overring or interfering with any persisted state. Additionally, if the guest VM has any physical devices assigned thereto, embodiments may allocate physical device queues (e.g., NVMe queues) within the memory block.

Method 500b also comprises act 515 of restoring the HCL operating state. In some embodiments, act 515 comprises restoring the operating state. As mentioned, in various embodiments, persisting the operating state may include persisting the state to a location within the HCL's memory space or to a host partition. In embodiments in which persisting the operating state to the storage includes saving the operating state to a memory block within the memory space of the HCL, restoring the operating state in act 515 includes loading the operating state from the memory block within the memory space of the HCL, e.g., based on convention. In some embodiments, this includes identifying a value indicating that the operating state is stored at the memory block.

In embodiments in which the persisting of the operating state to the storage includes sending the operating state to a host partition, restoring the operating state in act 515 includes receiving the operating state from the host partition. Returning to method 500a, in some embodiments, method 500a also comprises act 510 of assisting with restoring the HCL state. For example, operating state restoration component 205 provides the state to guest partition 111a.

As mentioned, variations are also possible, such as persisting the state 118 within context 113 but notifying operating state persistence component 203 of the memory location at which that state can be found. Thus, in some embodiments, loading the operating state from the memory block within the memory space of the HCL includes receiving the identity of the location of the memory block within the memory space of the HCL from operating state restoration component 205.

Returning to method 500b, method 500b also comprises act 516 of resuming execution of the guest OS. In some embodiments, act 516 comprises resuming the execution of the guest OS after restoring the operating state. For example, HCL 116, now running updated HCL 124, resumes the execution of guest OS 115.

Embodiments of the disclosure comprise or utilize a special-purpose or general-purpose computer system (e.g., computer system 101) that includes computer hardware, such as, for example, a processor system (e.g., processor system 103) and system memory (e.g., memory 104), as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media (e.g., storage medium 105). Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 106) and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAS, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (Saas), Platform as a Service (PaaS), Infrastructure as a Service (laaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more VMs. During operation, VMs emulate an operational computing system, supporting an OS and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method, implemented in a virtual machine (VM) host computer system that includes a processor system, comprising:
determining that an update is available for a host compute layer (HCL) of a guest VM operating at the VM host computer system;
sending a message to the HCL of the guest VM, wherein, based on the message, the HCL persists an operating state of the HCL, including,
pausing an execution of a guest operating system (OS) within the guest VM, and
persisting the operating state after pausing the execution of the guest OS; and
after sending the message to the HCL of the guest VM,
stopping a virtual processor (VP) system associated with the guest VM,
setting a register at the VP system to a power-on value or a reset value,
copying an updated HCL into a memory space of the HCL within the guest VM, and
resuming the VP system, wherein, based on the register, the VP system executes the updated HCL, which,
restores the operating state, and
resumes the execution of the guest OS after restoring the operating state.

2. The method of claim 1, wherein the method further comprises, before sending the message to the HCL, determining that the guest VM is in a state that permits updating the HCL, including determining that the VP system is running.

3. The method of claim 1, wherein the method further comprises:
before sending the message to the HCL, determining that the guest VM is in a state that prevents updating the HCL, including determining that the VP system is not running; and
deferring sending the message to the HCL.

4. The method of claim 1, wherein the operating state includes at least one of,
a register value at the VP system that was written by the guest OS before the guest OS was paused,
a first state of a virtual hardware device operated by the HCL, or
a second state of a physical hardware device assigned to the guest VM.

5. The method of claim 1, wherein the method further comprises, before sending the message to the HCL, validating at least one of,
that the updated HCL is compatible with the HCL, or
that the updated HCL is valid.

6. The method of claim 1, wherein persisting the operating state includes at least one of,
sending the operating state to a host partition, or
saving the operating state to a memory block within the memory space of the HCL.

7. The method of claim 6, wherein restoring the operating state includes at least one of,
receiving the operating state from the host partition, or
loading the operating state from the memory block within the memory space of the HCL.

8. The method of claim 7, wherein,
saving the operating state to the memory block within the memory space of the HCL includes sending an identity of a location of the memory block within the memory space of the HCL to the host partition, and
loading the operating state from the memory block within the memory space of the HCL includes receiving the identity of the location of the memory block within the memory space of the HCL from the host partition.

9. The method of claim 7, wherein,
the memory block is determined by the HCL based on convention,
saving the operating state to the memory block within the memory space of the HCL includes writing a value indicating that the operating state is stored at the memory block, and
loading the operating state from the memory block within the memory space of the HCL includes identifying the value indicating that the operating state is stored at the memory block.

10. A method, implemented in a host compute layer (HCL) of a guest virtual machine (VM) that includes a virtual processor (VP) system, comprising:
receiving a message from a host partition to persist an operating state of the HCL;
based on the message,
pausing an execution of a guest operating system (OS) within the guest VM, and
persisting the operating state after pausing the execution of the guest OS; and
after persisting the operating state, booting HCL code, including:
restoring the operating state, and
resuming the execution of the guest OS after restoring the operating state.

11. The method of claim 10, wherein the operating state includes at least one of,
a register value at the VP system that was written by the guest OS before the guest OS was paused,
a first state of a virtual hardware device operated by the HCL, or
a second state of a physical hardware device assigned to the guest VM.

12. The method of claim 10, wherein persisting the operating state includes at least one of,
sending the operating state to the host partition, or
saving the operating state to a memory block within a memory space of the HCL.

13. The method of claim 12, wherein restoring the operating state includes at least one of,
receiving the operating state from the host partition, or
loading the operating state from the memory block within the memory space of the HCL.

14. The method of claim 13, wherein,
saving the operating state to the memory block within the memory space of the HCL includes sending an identity of a location of the memory block within the memory space of the HCL to the host partition, and
loading the operating state from the memory block within the memory space of the HCL includes receiving the identity of the location of the memory block within the memory space of the HCL from the host partition.

15. The method of claim 13, wherein,
the memory block is determined by the HCL based on convention,
saving the operating state to the memory block within the memory space of the HCL includes writing a value indicating that the operating state is stored at the memory block, and
loading the operating state from the memory block within the memory space of the HCL includes identifying the value indicating that the operating state is stored at the memory block.

16. The method of claim 10, wherein booting the HCL includes excluding a memory block from use by HCL services.

17. The method of claim 16, wherein the method further comprises allocating physical device queue within the memory block.

18. A computer system, comprising:
a processor system; and
computer storage media that store computer-executable instructions that are executable by the processor system to at least:
at a host partition:
determine that an update is available for a host compute layer (HCL) of a guest virtual machine (VM);
send a message to the HCL; and
after sending the message to the HCL,
stop a virtual processor (VP) system associated with the guest VM,
set a register at the VP system to a power-on value or a reset value,
copy an updated HCL into a memory space of the HCL within the guest VM, and
resume the VP system; and
at the guest VM:
based on receiving the message from the host partition,
pause an execution of a guest operating system (OS) within the guest VM, and
persist operating state after pausing the execution of the guest OS; and
based on the host partition resuming the VP system, and based on the register at the VP system, boot the updated HCL, including,
restoring the operating state, and
resuming the execution of the guest OS after restoring the operating state.

19. The computer system of claim 18, wherein the operating state includes at least one of,
a register value at the VP system that was written by the guest OS before the guest OS was paused;
a first state of a virtual hardware device operated by the HCL; or
a second state of a physical hardware device assigned to the guest VM.

20. The computer system of claim 18, wherein,
persisting the operating state includes at least one of,
sending the operating state to the host partition, or
saving the operating state to a memory block within the memory space of the HCL, and
restoring the operating state includes at least one of,
receiving the operating state from the host partition, or
loading the operating state from the memory block within the memory space of the HCL.
